(19) United States
(12) Patent Application Publication
(10) Pub. No.: US 2008/0174987 A1
(43) Pub. Date: Jul. 24, 2008

(54) Illuminated eye loupe

(75) Inventor: Sudhir Kumar Mundhra, Cerritos, CA (US)

Correspondence Address: Cislo & Thomas LLP, 1333 2nd Street, Suite #500, Santa Monica, CA, 90401-4110, US

(73) Assignees: SIYA, Inc.; d/b/a Sona Enterprises

(21) Appl. No.: 11/654,788

(22) Filed: Jan. 18, 2007

(51) Int. Cl. F21V 33/00

(52) U.S. Cl. 362/109; 362/138

(57) ABSTRACT

A hand-held illuminated eye loupe includes an open top and bottom housing with an internal magnifying lens. A light source assembly is removably coupled to one side of the housing. The light source assembly includes a hollow chassis configured to retain a LED which provides focused light beam adjacent to the open bottom of the housing. The LED has positive and negative terminal wires. Four cell batteries are operatively stacked between the negative terminal wire and a connector plate. A light switch assembly is coupled to the chassis and configured to embed a portion of the positive terminal wire. The embedded terminal wire includes a curved end which makes electrical contact with the connector plate to turn the LED on when the switch is pushed toward the LED. The curved end pulls away from the connector plate to turn the LED off when the switch is pushed away from the LED.

### COPYRIGHT NOTICE

Portions of the disclosure of this patent document may contain material that is subject to copyright and/or mask work protection. The copyright and/or mask work owner has no objection to the facsimile reproduction by anyone of the patent document or the patent disclosure, as it appears in the U.S. Patent and Trademark Office patent file or records, but otherwise reserves all copyright and/or mask work rights whatsoever.

### BACKGROUND

Various optical magnifying devices for enabling a person to view objects more clearly are known. Some of these devices have built-in magnifying lenses which make it possible to bring an object being viewed comfortably within the eye's range of accommodation. This is the range of distance within which the lens can produce a sharply focused image on the retina.

Various types of optical aids have been used to facilitate close viewing. Some of these optical aids come with a retractable light source which illuminates the field of view and enables the user to view various items or objects more clearly, as needed.

Some of these optical aids present problems in regard to the nature of illumination such as glare which may be caused by the source of illumination not being coupled directly to the magnifying lens housing. Glare results in uneven illumination of the object being viewed by the user. Moreover, these optical aids may utilize sources of illumination which are not readily detachable and/or are generally not capable of providing a sharply focused light beam.

It would therefore be desirable to provide a hand-held eye loupe with a LED (Light Emitting Diode) light source that is removably coupled to the magnifying lens housing. Such a LED light source would give out a focused light beam on the object being viewed and may be easily detachable for maintenance by the user. The LED light source may be inexpensively powered by one or more integral low voltage power sources.

### SUMMARY

Some embodiments disclosed herein are generally directed to an illuminated eye loupe.

In accordance with one aspect of the present invention, the illuminated eye loupe comprises a hollow housing configured to receive and retain internally at least one magnifying lens, and a light source assembly removably coupled to one side of the hollow housing. The light source assembly includes at least one LED (Light Emitting Diode) configured to provide focused light beam adjacent to an area being viewed through the magnifying lens. The LED includes a positive terminal wire and a negative terminal wire.

The light source assembly also includes at least one power source operatively coupled to the negative terminal wire, and at least one electrical connector plate. The connector plate is operatively coupled to the power source. The light source assembly further includes a light switch assembly configured to embed a portion of the positive terminal wire. The embedded terminal wire includes a curved end which makes electrical contact with the connector plate to turn the LED on when the light switch assembly is pushed toward the LED. The curved end pulls away from the connector plate to turn the LED off when the light switch assembly is pushed away from the LED.

In accordance with another aspect of the present invention, the illuminated eye loupe comprises a hollow housing having a substantially truncated cone shape. The housing is configured to receive and retain internally a magnifying lens between an open top and an open bottom. The open bottom is configured for viewing at least one area in need of optical magnification.

The illuminated eye loupe further comprises a light source assembly which is removably coupled to one side of the housing. The light source assembly includes a substantially elongated chassis with a hollow interior, and a LED (Light Emitting Diode) being retained within the hollow chassis. The retained LED is configured to provide focused light beam adjacent to the open bottom of the housing. The LED is fitted with a positive terminal wire and a negative terminal wire.

The light source assembly also includes a plurality of low voltage power sources being retained within the hollow chassis. The retained power sources are operatively disposed over the negative terminal wire. A connector plate is also retained within the hollow chassis. The retained connector plate is operatively disposed over the power sources.

A light switch assembly is operatively coupled to the chassis and configured to embed a portion of the positive terminal wire. The embedded terminal wire includes a curved end which makes electrical contact with the connector plate to turn the LED on when the light switch assembly is pushed toward the LED. The curved end pulls away from the connector plate to turn the LED off when the light switch assembly is pushed away from the LED.

In accordance with still another aspect of the present invention, the illuminated eye loupe comprises a main housing having a substantially truncated cone shape. The main housing is configured to receive and retain internally a first magnifying lens between an open top and an open bottom. The open bottom is configured for viewing at least one area in need of optical magnification.

The illuminated eye loupe further comprises a light source assembly which is removably coupled to one side of the main housing. The light source assembly includes a substantially elongated chassis with a hollow interior, and a LED (Light Emitting Diode) being retained within the hollow chassis. The retained LED is configured to provide focused light beam adjacent to the open bottom of the main housing. The LED is fitted with a positive terminal wire and a negative terminal wire.

The light source assembly also includes a plurality of low voltage power sources being retained within the hollow chassis. The retained power sources are operatively disposed over the negative terminal wire. A connector plate is also retained within the hollow chassis. The retained connector plate is operatively disposed over the power sources.

A light switch assembly is operatively coupled to the chassis and configured to embed a portion of the positive terminal wire. The embedded terminal wire includes a curved end which makes electrical contact with the connector plate to turn the LED on when the light switch assembly is pushed toward the LED. The curved end pulls away from the connector plate to turn the LED off when the light switch assembly is pushed away from the LED.

An auxiliary housing is configured for insertion into the main housing via its open bottom. The inserted auxiliary housing is fitted internally with a second magnifying lens to alter the optical magnification power of the first magnifying lens. The second magnifying lens is recessed relative to an outer lip of the auxiliary housing.

These and other aspects of the invention will become apparent from a review of the accompanying drawings and the following detailed description of the invention.

### BRIEF DESCRIPTION OF THE DRAWINGS

The present invention is generally shown by way of reference to the accompanying drawings in which:

FIG. 1 is a perspective view showing an illuminated eye loupe being used in accordance with the present invention;

FIG. 2 is an exploded component view of the illuminated eye loupe of FIG. 1;

FIG. 3 is a top plan view of a detachable LED (Light Emitting Diode) assembly for use with the eye loupe of the present invention;

FIG. 4 is a cross-sectional view along section line 4-4 of FIG. 3;

FIG. 5 is a cross-sectional view along section line 5-5 of FIG. 3;

FIG. 6 is a first detailed LED assembly area view (as indicated by reference numeral 6 in FIG. 4) in accordance with the present invention;

FIG. 7 is a second detailed LED assembly area view in accordance with the present invention;

FIG. 8 is a side elevation of the LED assembly of FIG. 2 in accordance with one embodiment of the present invention;

FIG. 9 is a side elevation of the LED assembly of FIG. 2 in accordance with another embodiment of the present invention;

FIG. 10 is an exploded component view of an illuminated eye loupe in accordance with an alternative embodiment of the present invention; and

FIG. 11 is a bottom plan view of one of the components (an auxiliary eye loupe unit) shown in the embodiment of FIG. 10.

### DETAILED DESCRIPTION

The detailed description set forth below in connection with the appended drawings is intended as a description of illustrated exemplary embodiments and is not intended to represent the only forms in which these embodiments may be constructed and/or utilized. The description sets forth the functions and sequence of steps for constructing and operating the present invention in connection with the illustrated embodiments. However, it is to be understood that the same or equivalent functions and/or sequences may be accomplished by different embodiments that are also intended to be encompassed within the spirit and scope of the present invention.

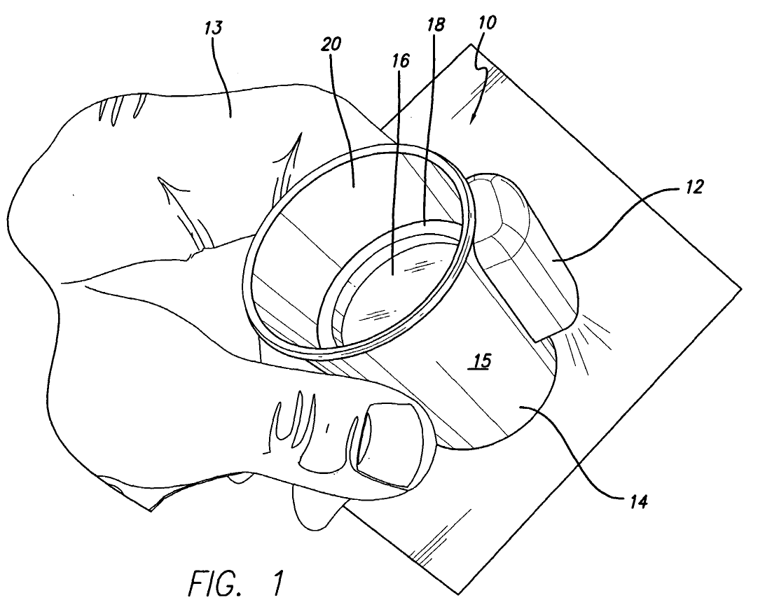

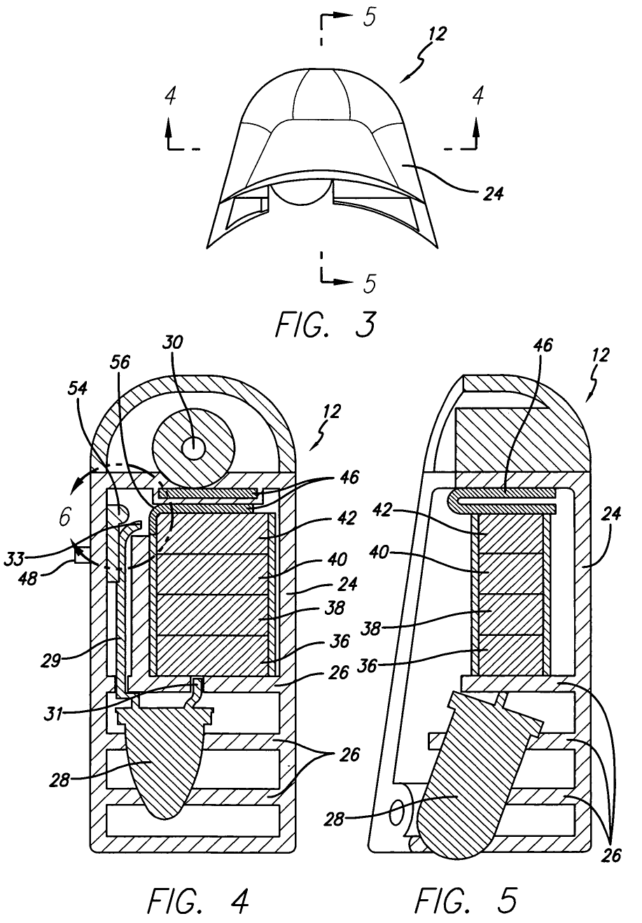

Some embodiments of the present invention will be described in detail with reference to an illuminated eye loupe, as generally shown in FIGS. 1-9. Additional embodiments, features and/or advantages of the invention will become apparent from the ensuing description or may be learned by practicing the invention. In the attached figures, the various drawings are not to scale with like numerals referring to like features throughout both the drawings and the description.

FIG. 1 is a perspective view showing an illuminated eye loupe 10 being used in accordance with the present invention. Illuminated eye loupe 10 includes a detachable LED (Light Emitting Diode) assembly 12 which has a hollow interior. LED assembly 12 may be removably coupled to one side of an eye loupe housing 14 and configured to conveniently illuminate a corresponding viewable area for a user 13, as generally indicated in reference to FIG. 1.

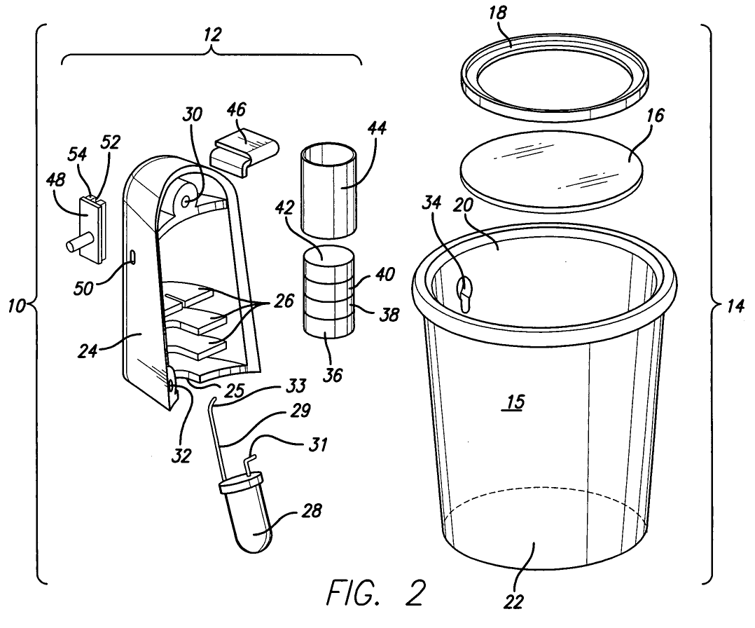

Eye loupe housing 14 includes a hollow body 15 with a generally truncated cone shape which is suitable for hand-holding (FIG. 1) during use. Hollow body 15 is configured to receive and retain a magnifying lens 16 via an appropriately configured lens retention ring 18, as generally illustrated in reference to FIG. 2. Magnifying lens 16 may be of the type used by jewelers and watchmakers, i.e. from 2 to 20 power. Magnifying lens 16 may be configured with a higher power, as needed. When assembled and configured properly, illuminated eye loupe 10 may also be suitable for use by surgeons, dentists, physicians, engineers, librarians, teachers and/or the like.

Hand-held eye loupe housing 14 has an open top 20 (FIGS. 1-2) which may be configured to fit in the eye socket of user 13 during viewing, if needed. Open top 20 may also be configured for attachment to spectacle(s) of user 13. Eye loupe housing 14 has an open bottom 22 (FIG. 2) which may be configured for viewing any area that needs magnification.

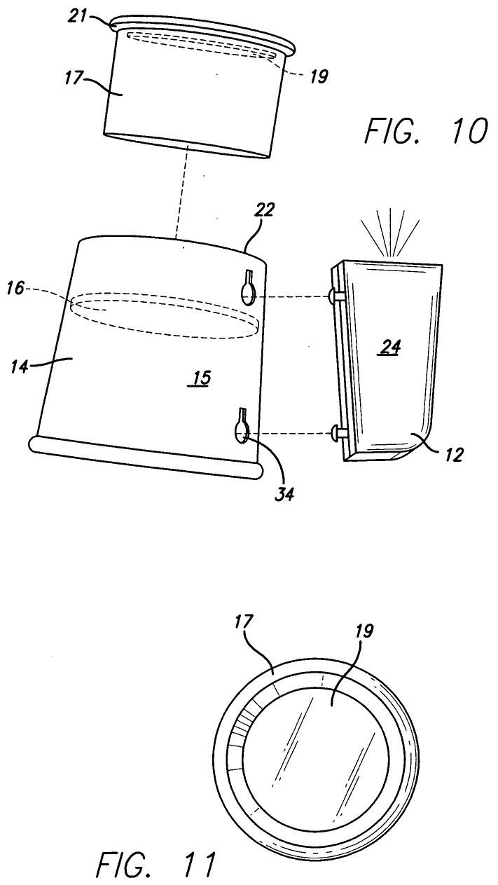

In accordance with an alternative embodiment of the present invention, hand-held eye loupe housing 14 may be fitted with a removable auxiliary eye loupe unit 17 (FIGS. 10-11) to vary the power of magnification. Auxiliary eye loupe unit 17 includes an integral magnifying lens 19 (FIGS. 10-11) which is recessed somewhat relative to an outer lip 21 (FIG. 10). Auxiliary eye loupe unit 17 is shaped to allow insertion of the same into open bottom 22 of eye loupe housing 14, as generally illustrated in FIG. 10, to alter the magnification power of illuminated eye loupe 10. Inserted eye loupe unit 17 is being held within eye loupe housing 14 via friction. Auxiliary eye loupe unit 17 is adapted for easy removal from hollow body 15 by the user. More than one auxiliary eye loupe units may be utilized by the user, as needed.

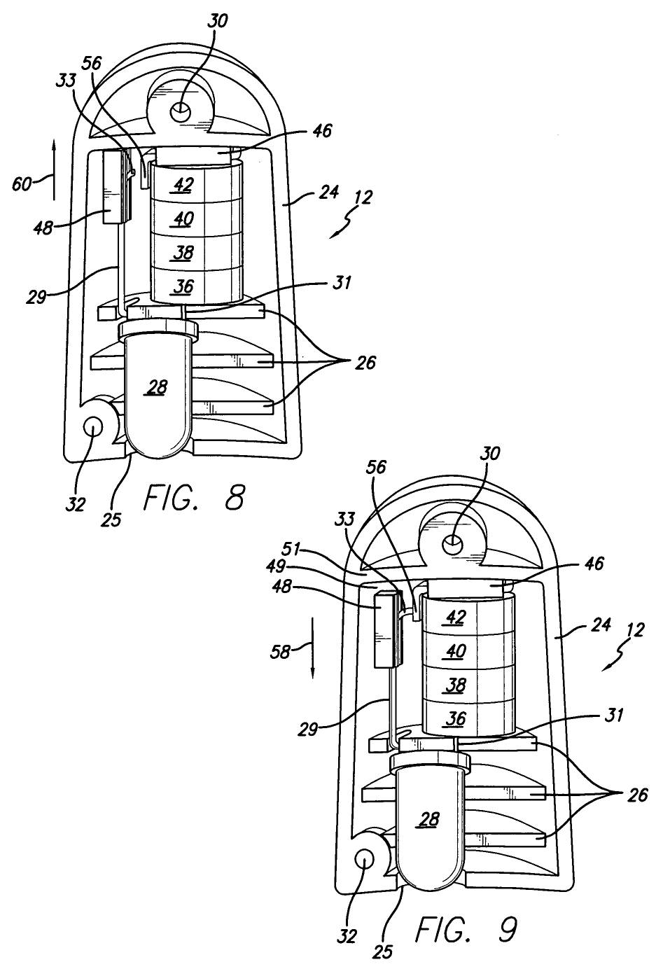

LED assembly 12 comprises a generally elongated chassis 24 which has a hollow interior. Chassis 24 includes internally an integral rib-like structure 26 adapted to retain and support a LED (Light Emitting Diode) 28, as shown, for example, in reference to FIGS. 8-9. LED 28 includes positive (long) terminal wire 29 and negative (short) terminal wire 31, as shown in FIG. 2. Chassis 24 has apertures 30 and 32 (FIGS. 2, 4 and 8-9) which may be configured to receive loupe housing connectors, such as screws (FIG. 10) and the like. Each connector (screw) may be adapted for coupling to an appropriately configured aperture, such as aperture 34 (FIG. 2), on loupe housing body 15. Chassis 24 is suitably apertured at the bottom, as shown, for example, at 25 in reference to FIGS. 2 and 8-9, to accommodate the tip of LED 28, i.e. to allow light from the LED power source to illuminate an area that is being viewed by the user (FIG. 1).

LED 28 is powered by four vertically stacked button cell batteries 36, 38, 40 and 42, as generally indicated in reference to FIGS. 2, 4-5 and 8-9. Button cell batteries suitable for practicing the present invention may be, for example, of the SR621SW or ETA 377 1.5 volt type (Swiss made or AG1) or the like. A sleeve 44 (FIG. 2) may be utilized to receive and hold button cell batteries 36, 38, 40 and 42 for ease of assembly. Sleeve 44 may have an annular cross-section.

A connector plate 46 (FIGS. 2, 4-9) made of electrically conductive material such as phosphor bronze or the like sits on top of button cell battery 42 (which is part of the vertically stacked button cell battery configuration), as shown, for example, in FIGS. 4-5 and 8-9. Connector plate 46 has a generally L-shaped cross-section. When loupe housing 14 is properly assembled, connector plate 46 makes electrical contact with button cell battery 42, which in turn makes electrical contact with button cell battery 40, which is in electrical contact with button cell battery 38, which is in electrical contact with button cell battery 36. Button cell battery 36 sits on top of negative (short) terminal wire 31 of LED 28 making electrical contact with the same, as generally illustrated in reference to FIGS. 4-5 and 8-9.

LED assembly 12 (FIG. 2) also includes a switch assembly 48 which may be operatively coupled to chassis 24 via exterior wall aperture 50. Switch assembly 48 is provided on one side with a channel 52 (FIG. 2) adapted to accommodate positive (long) terminal wire 29 of LED 28 during assembly. Terminal wire channel 52 is embedded in the middle of a generally rib-like switch structure 54 (FIGS. 2, 6-7) which is disposed in the vicinity of vertical portion 56 (FIGS. 4, 6-9) of connector plate 46 during assembly.

Embedded terminal wire 29 (of LED 28) has a curved end 33 which projects out of rib-like switch structure 54 and abuts against vertical portion 56 (FIGS. 4, 6-9) of connector plate 46 making electrical contact with the same (i.e. closes the electrical circuit) when switch assembly 48 is pushed down by user 13 (also defined as “on” position), as generally indicated by directional arrow 58 in FIG. 9. The “on” position of switch assembly 48 creates a gap 49 between inner frame wall 51 of chassis 24 and the top of rib-like switch structure 54, as generally depicted in FIG. 9.

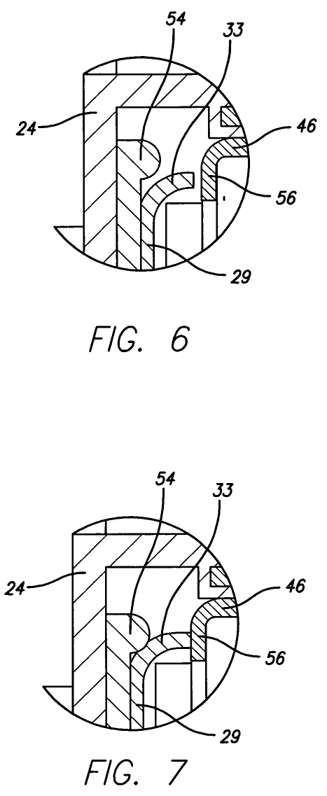

Curved terminal wire end 33 pulls away from vertical portion 56 of connector plate 46 (i.e. opens the electrical circuit) when switch assembly 48 is pushed up by user 13 (also defined as “off” position), as generally indicated by directional arrow 60 in FIG. 8. The “off” position is shown in detail in reference to FIG. 6. The “on” position is shown in detail in reference to FIG. 7. Gap 49 is closed in the “off” position, as generally depicted in FIG. 8.

The hand-held illuminated eye loupe of the present invention provides a focused light beam on object(s) being viewed by the user. The LED assembly may be easily detached from or attached to the loupe housing by the user, as needed. The eye loupe of the present invention utilizes a plurality of button cell batteries which consume very low power during use and provide for a prolonged trouble-free operation. The eye loupe housing and LED chassis may be manufactured from plastic and/or other suitable material(s). The LED and button cell batteries are readily available from commercial sources at inexpensive retail and/or wholesale prices.

A person skilled in the art would undoubtedly recognize that the hand-held illuminated eye loupe of the present invention may be configured to operate with more than one integral LED light sources, as needed. Also, the hand-held illuminated eye loupe of the present invention may be adapted to utilize more or less than four button cell batteries, as desired. Other suitable sources of power may be used, as desired.

The exemplary embodiments described hereinabove are merely illustrative of the general principles of the present invention. Various design modifications may be employed that would reside within the scope of the invention. Thus, by way of example, but not of limitation, various alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed:

1. An illuminated eye loupe, comprising:
a hollow housing configured to receive and retain internally at least one magnifying lens; and
a light source assembly removably coupled to one side of said hollow housing, said light source assembly comprising:
at least one LED (Light Emitting Diode) configured to provide focused light beam adjacent to an area being viewed through said at least one magnifying lens, said at least one LED including a positive terminal wire and a negative terminal wire;
at least one power source operatively coupled to said negative terminal wire;
at least one electrical connector plate operatively coupled to said at least one power source;
a light switch assembly configured to embed a portion of said positive terminal wire, said embedded terminal wire including a curved end which makes electrical contact with said at least one electrical connector plate to turn said at least one LED on when said light switch assembly is pushed toward said at least one LED, said curved end pulling away from said at least one electrical connector plate to turn said at least one LED off when said light switch assembly is pushed away from said at least one LED.

2. An illuminated eye loupe, comprising:
a hollow housing having a substantially truncated cone shape, said housing configured to receive and retain internally a magnifying lens between an open top and an open bottom, said open bottom being configured for viewing at least one area in need of optical magnification; and
a light source assembly removably coupled to one side of said housing, said light source assembly comprising:
a substantially elongated chassis with a hollow interior;
a LED (Light Emitting Diode) being retained within said hollow chassis, said retained LED being configured to provide focused light beam adjacent to said open bottom of said housing, said LED fitted with a positive terminal wire and a negative terminal wire;
a plurality of low voltage power sources being retained within said hollow chassis, said retained power sources being operatively disposed over said negative terminal wire;
a connector plate being retained within said hollow chassis, said retained connector plate being operatively disposed over said power sources;
a light switch assembly operatively coupled to said chassis and configured to embed a portion of said positive terminal wire, said embedded terminal wire including a curved end which makes electrical contact with said connector plate to turn said LED on when said light switch assembly is pushed toward said LED, said curved end pulling away from said connector plate to turn said LED off when said light switch assembly is pushed away from said LED.

3. An illuminated eye loupe, comprising:
a main housing having a substantially truncated cone shape, said main housing configured to receive and retain internally a first magnifying lens between an open top and an open bottom, said open bottom being configured for viewing at least one area in need of optical magnification;
a light source assembly removably coupled to one side of said main housing, said light source assembly comprising:
a substantially elongated chassis with a hollow interior;
a LED (Light Emitting Diode) being retained within said hollow chassis, said retained LED being configured to provide focused light beam adjacent to said open bottom of said main housing, said LED fitted with a positive terminal wire and a negative terminal wire;
a plurality of low voltage power sources being retained within said hollow chassis, said retained power sources being operatively disposed over said negative terminal wire;
a connector plate being retained within said hollow chassis, said retained connector plate being operatively disposed over said power sources;
a light switch assembly operatively coupled to said chassis and configured to embed a portion of said positive terminal wire, said embedded terminal wire including a curved end which makes electrical contact with said connector plate to turn said LED on when said light switch assembly is pushed toward said LED, said curved end pulling away from said connector plate to turn said LED off when said light switch assembly is pushed away from said LED; and
an auxiliary housing configured for insertion into said main housing via said open bottom, said inserted auxiliary housing fitted internally with a second magnifying lens to alter the optical magnification power of said first magnifying lens, said second magnifying lens being recessed relative to an outer lip of said auxiliary housing.

4. The illuminated eye loupe of claim 2, wherein said magnifying lens has an optical magnification power in the range of 2 to 20.

5. The illuminated eye loupe of claim 2, wherein said magnifying lens has an optical magnification power over 20.

6. The illuminated eye loupe of claim 2, wherein said truncated cone housing is made of plastic.

7. The illuminated eye loupe of claim 2, wherein said chassis is made of plastic.

8. The illuminated eye loupe of claim 2, wherein said chassis is apertured at one end to accommodate the tip of said LED.

9. The illuminated eye loupe of claim 2, wherein said chassis includes a plurality of integral support ribs configured to securely retain said LED.

10. The illuminated eye loupe of claim 2, wherein said chassis includes at least one aperture configured to receive an eye loupe connector.

11. The illuminated eye loupe of claim 10, wherein said eye loupe connector is a screw.

12. The illuminated eye loupe of claim 10, wherein said eye loupe connector is coupled to a corresponding aperture on said hollow housing.

13. The illuminated eye loupe of claim 2, wherein said plurality of low voltage power sources includes four vertically stacked button cell batteries.

14. The illuminated eye loupe of claim 13, wherein said vertically stacked button cell batteries are of the SR621SW 1.5 volt type.

15. The illuminated eye loupe of claim 13, wherein said vertically stacked button cell batteries are of the ETA 377 1.5 volt type.

16. The illuminated eye loupe of claim 13, further comprising a sleeve configured to hold said vertically stacked button cell batteries for ease of assembly.

17. The illuminated eye loupe of claim 16, wherein said sleeve has an annular cross-section.

18. The illuminated eye loupe of claim 2, wherein said connector plate is made of electrically conductive material.

19. The illuminated eye loupe of claim 18, wherein said electrically conductive material includes phosphor bronze.

20. The illuminated eye loupe of claim 2, wherein said light switch assembly includes at least two support ribs disposed away from each other.

21. The illuminated eye loupe of claim 20, wherein the disposition of said at least two support ribs defines an interior channel suitable for embedding a portion of said positive terminal wire.

22. The illuminated eye loupe of claim 2, wherein said truncated cone housing is configured for convenient hand-holding during use.

23. The illuminated eye loupe of claim 3, wherein said substantially truncated cone shape of said main housing is configured for convenient hand-holding during use.
